(19) United States
(12) Patent Application Publication
(10) Pub. No.: US 2020/0240177 A1
(43) Pub. Date: Jul. 30, 2020

(54) DOOR LOCK DEVICE HAVING EASY INSTALLATION STRUCTURE

(71) Applicant: Gianni Industries Inc., Taipei (TW)

(72) Inventor: Chih Chung CHANG, Taipei (TW)

(21) Appl. No.: 16/257,114

(22) Filed: Jan. 25, 2019

(51) Int. Cl. E05B 63/24; E05B 65/10; E05B 63/00

(52) U.S. Cl. CPC E05B 63/244; E05B 63/0052; E05B 65/1053

(57) ABSTRACT

A door lock device is worked in cooperate with a latch bolt, a press bar is attached to a door element and engaged with a locking pin and the latch bolt, a housing is attached to a door member, and a block device includes a board engaged into the chamber of the housing and secured to the housing, and the board includes a lever extended from the board for aligning with the locking pin and for selectively engaging with the locking pin and for preventing the locking pin from engaging into the chamber of the housing. The housing includes an opening formed in one side and communicating with the chamber of the housing for allowing the latch bolt to be engaged into the chamber of the housing. The lever of the board is engaged in the opening of the housing.

### BACKGROUND OF THE INVENTION

### 1. Field of the Invention

The present invention relates to a door lock device, and more particularly to a door lock device including an improved and simplified structure or mechanism for allowing the door lock device to be suitably and easily and quickly and readily attached or mounted or secured to the door frame or door member without adjusting the attaching location or position of the door lock device to the door frame or door member.

### 2. Description of the Prior Art

Various kinds of typical lock devices, such as touch bar exit devices, fire door exit devices, electric dropbolts, cathode locks or the like have been developed and provided for conducting or operating or locking and unlocking various door devices, and normally comprise a deadbolt or tongue for locking or unlocking a door or window or the like.

For example, U.S. Pat. No. 5,219,385 to Yeh, U.S. Pat. No. 5,605,362 to Surko, Jr., U.S. Pat. No. 6,009,732 to Haeck et al., U.S. Pat. No. 6,032,985 to Cutter, and U.S. Pat. No. 6,623,050 B1 to Peng disclose several of the typical deadbolt lock devices each also comprising a deadbolt or tongue attached to a door panel for engaging with a lock device or the like that is attached to a door frame or the like, and for selectively locking a door panel to a door frame or the like, and a lock member disposed or engaged in the strike lock device for engaging with the deadbolt or tongue and for selectively latching and anchoring or retaining or positioning the tongue to the strike lock device and for preventing the tongue from being disengaged or separated from the strike lock device.

However, the lock device or lock member should be precisely attached or mounted or secured to the door frame or door member at the selected or predetermined or required position or location, once the lock device or lock member is not attached or mounted or secured to the door frame or door member at the selected or predetermined or required position or location, the deadbolt or tongue may not be suitably aligned with and engaged with the lock device or lock member, and the typical deadbolt lock devices thus may not suitably anchor or retain or position the deadbolt or tongue to the lock device and may not suitably lock the door panel to the door frame.

The present invention has arisen to mitigate and/or obviate the afore-described disadvantages of the conventional strike or door lock devices.

### SUMMARY OF THE INVENTION

The primary objective of the present invention is to provide a door lock device including an improved and simplified structure or mechanism for allowing the door lock device to be suitably and easily and quickly and readily attached or mounted or secured to the door frame or door member without adjusting the attaching location or position of the door lock device to the door frame or door member.

In accordance with one aspect of the invention, there is provided a door lock device attached to a door member for working in cooperate with a latch bolt which is attached to a door element, the door element including a press bar engaged with a locking pin and the latch bolt, the door lock device comprising a housing attached to the door member, the housing including a chamber formed in the housing; and a block device including a board engaged into the chamber of the housing and secured to the housing, and the board including a lever extended from the board for aligning with the locking pin and for selectively engaging with the locking pin and for preventing the locking pin from engaging into the chamber of the housing. The lever of the board of the block device may be selectively aligned with the locking pin for allowing the door lock device to be suitably and easily and quickly and readily attached or mounted or secured to the door frame or door member without adjusting the attaching location or position of the door lock device to the door frame or door member.

The housing includes a first side wall and a rear plate for forming the chamber of the housing, and the housing includes a second side wall having an opening communicating with the chamber of the housing for allowing the latch bolt to be engaged into the chamber of the housing. The lever of the board is engaged in the opening of the second side wall of the housing for selectively engaging with the locking pin.

The housing includes a cover secured to the housing, and the cover includes a space communicating with the chamber of the housing for allowing the latch bolt to be engaged into the chamber of the housing. The cover includes an entrance formed in a front wall and communicating with the space of the cover for allowing the latch bolt to be engaged into the space of the cover and then into the chamber of the housing. The lever of the board may be selectively engaged in the space of the cover for selectively engaging with the locking pin.

The housing includes a notch formed in a front portion of the housing and communicating with the chamber of the housing, and a strike engaged in the notch of the housing for engaging with the latch bolt and for guiding the latch bolt into the chamber of the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view illustrating an attachment of a door lock device in accordance with the present invention to a door device;

FIG. 2 is a partial perspective view of the door lock device as seen from the a direction different from that shown in FIG. 1;

FIG. 3 is a partial exploded view of the door lock device;

FIG. 4 is a partial front plan schematic view of the door device, illustrating the operation of the door lock device;

FIG. 5 is a partial top plan schematic view illustrating the operation of the door lock device; and

FIG. 6 is another partial top plan schematic view similar to FIG. 5, illustrating the operation of the door lock device.

### DETAILED DESCRIPTION OF THE PREFERRED EMBODIMENT

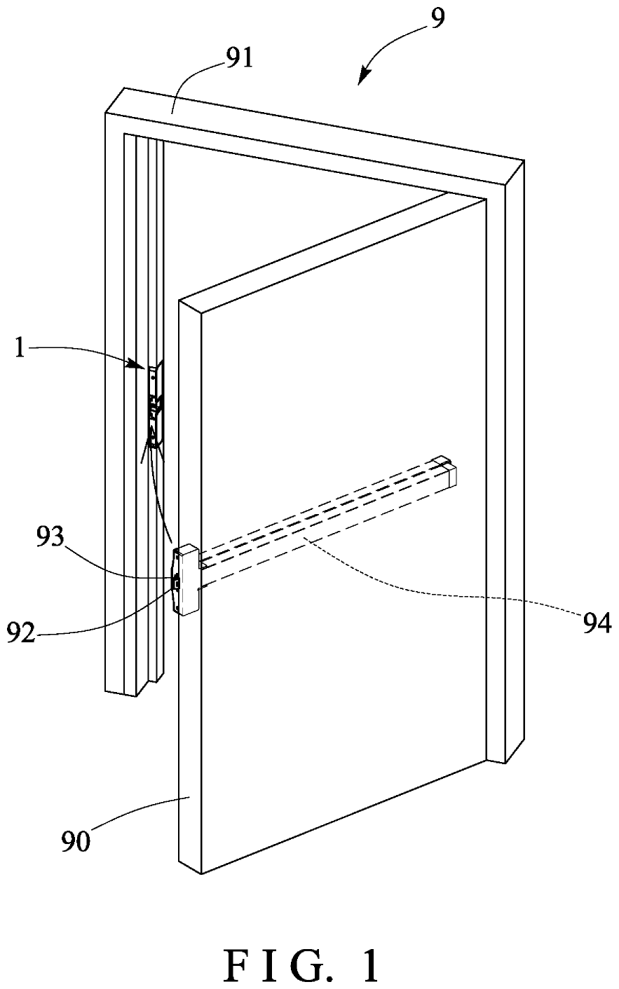

Referring to the drawings, and initially to FIGS. 1-4, a door lock device 1 in accordance with the present invention is developed and provided for locking and unlocking a door device 9 which includes a door member or door frame or door panel 90 and a door element or door panel or door frame 91, and the door panel or door member 90 of the door device 9 is worked in cooperate with the door frame or door element 91 of the door device 9. The door lock device 1 is attached or mounted or secured to the door frame or door element 91 of the door device 9, and the door panel or door member 90 of the door device 9 includes a latch bolt 92 and/or a deadbolt or locking pin 93 formed or provided or engaged therein for engaging with the door lock device 1 and for selectively anchoring or retaining or positioning or locking the door panel 90 to the door frame 91.

For example, the door device 9 may further include a hand grip or touch bar or press bar 94 attached or mounted or secured to the door panel 90, and engaged with and connected or coupled to the latch bolt 92 for actuating or operating the latch bolt 92 and for selectively disengaging or separating the latch bolt 92 from the door lock device 1. The above-described structure or configuration for the latch bolt 92 and the locking pin 93 and the press bar 94 is typical and is not related to the present invention and will not be described in further details. The attachment or engagement of the latch bolt 92 and the locking pin 93 with the door lock device 1 is also typical and has been disclosed and taught in the cited arts, and will not be described in further details.

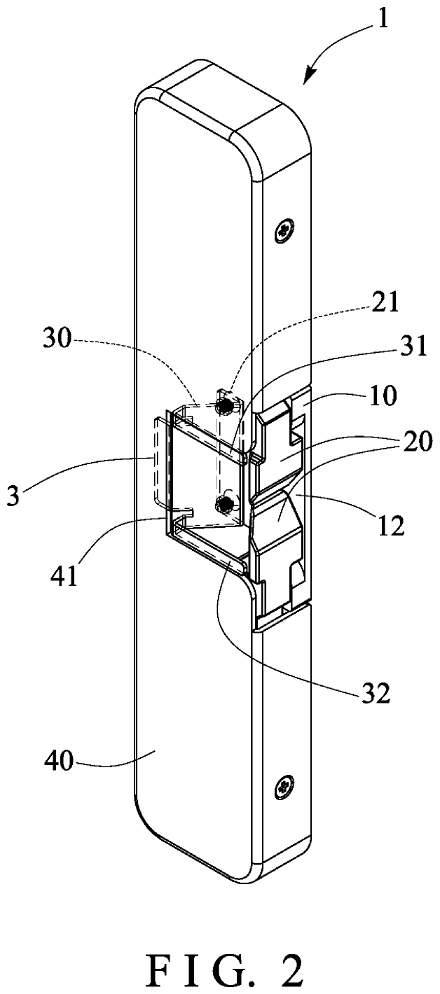

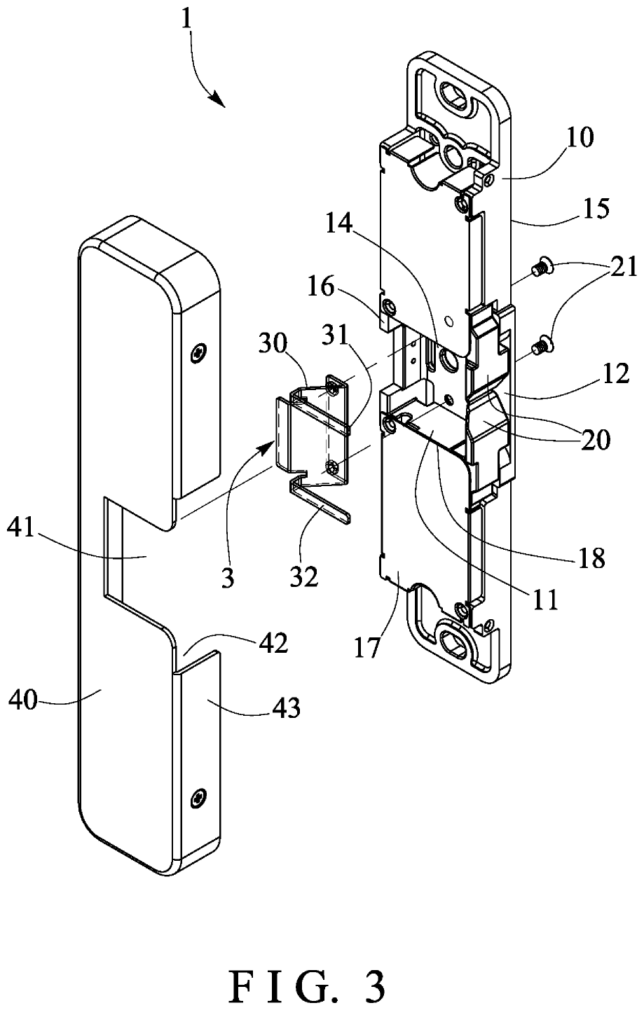

As shown in FIGS. 2-5, the door lock device 1 in accordance with the present invention comprises a base container or housing 10 disposed or engaged into the door frame or door element 91 (FIG. 1), and including a compartment or chamber 11 formed therein (FIG. 3) for receiving various parts or members or elements or the like therein, or for receiving or engaging with the latch bolt 92 and/or the locking pin 93. The door lock device 1 or the housing 10 includes an entrance or notch 12 formed in one side or front portion thereof and communicating with the chamber 11 of the housing 10 for guiding the latch bolt 92 into the chamber 11 of the housing 10. The housing 10 includes a gate or strike 20 disposed or engaged in the notch 12 of the housing 10 for engaging with the latch bolt 92 and/or the locking pin 93 and for guiding the latch bolt 92 and/or the locking pin 93 into the chamber 11 of the housing 10.

The door lock device 1 further includes a shield or block device 3 having a casing or plate or board 30 disposed or engaged into the chamber 11 of the housing 10 and attached or mounted or secured to the housing 10 with one or more (such as two) screws or bolts or latches or fasteners 21 or the like. The housing 10 includes a side plate or wall 14 formed or provided on one or first side portion 15 of the housing 10 and a rear panel or plate 16 for forming or defining the chamber 11 of the housing 10, and the housing 10 includes another notch or opening 18 formed therein, such as formed in the other or second side portion or wall 17 and communicating with the chamber 11 of the housing 10 for allowing the latch bolt 92 and/or the locking pin 93 to be engaged into the chamber 11 of the housing 10.

A hood or cover 40 is attached or mounted or secured to the housing 10 and includes a cut or opening or space 41 formed therein and aligned with and communicating with the chamber 11 of the housing 10 for allowing the latch bolt 92 and/or the locking pin 93 to be engaged into the chamber 11 of the housing 10, and includes an entrance 42 formed therein, such as formed in the front plate or front wall 43 and communicating with the space 41 of the cover 40 for allowing the latch bolt 92 and/or the locking pin 93 to be engaged into the space 41 of the cover 40 and the chamber 11 of the housing 10.

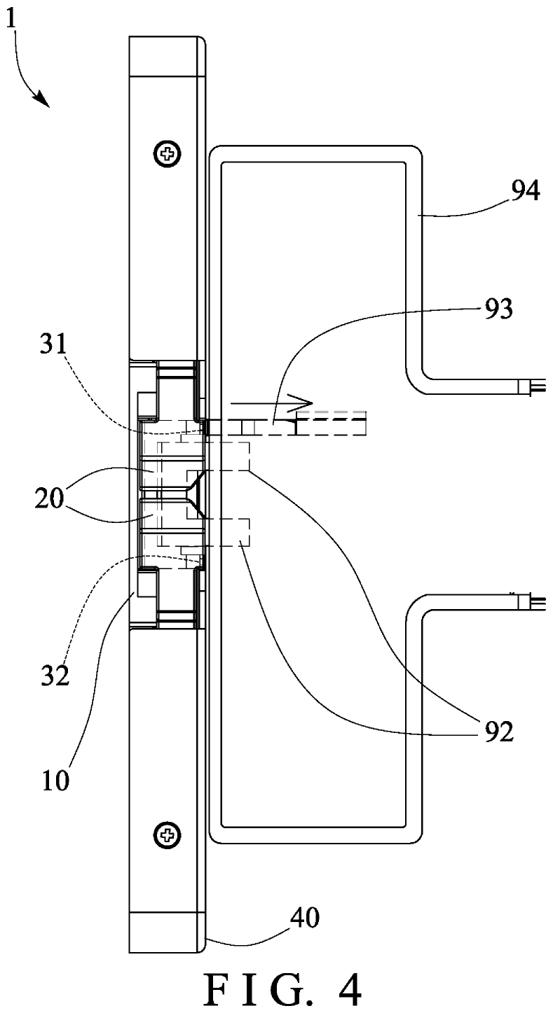

The block device 3 further includes one or more (such as two) legs or limbs or levers 31, 32 extended therefrom, such as extended from the board 30 and disposed or located or engaged in the opening 18 of the second side wall 17 of the housing 10, and/or disposed or located or engaged in the space 41 of the cover 40, and one of the levers 31 is aligned with the locking pin 93 (FIG. 4) for selectively engaging with the locking pin 93 and for preventing the locking pin 93 from engaging into the chamber 11 of the housing 10 (FIGS. 4, 6), and thus for allowing the locking pin 93 to be engaged with the latch bolt 92 and for latching or locking the latch bolt 92 in place (FIG. 6). The attachment or engagement of the latch bolt 92 with the locking pin 93 is also typical and will not be described in further details.

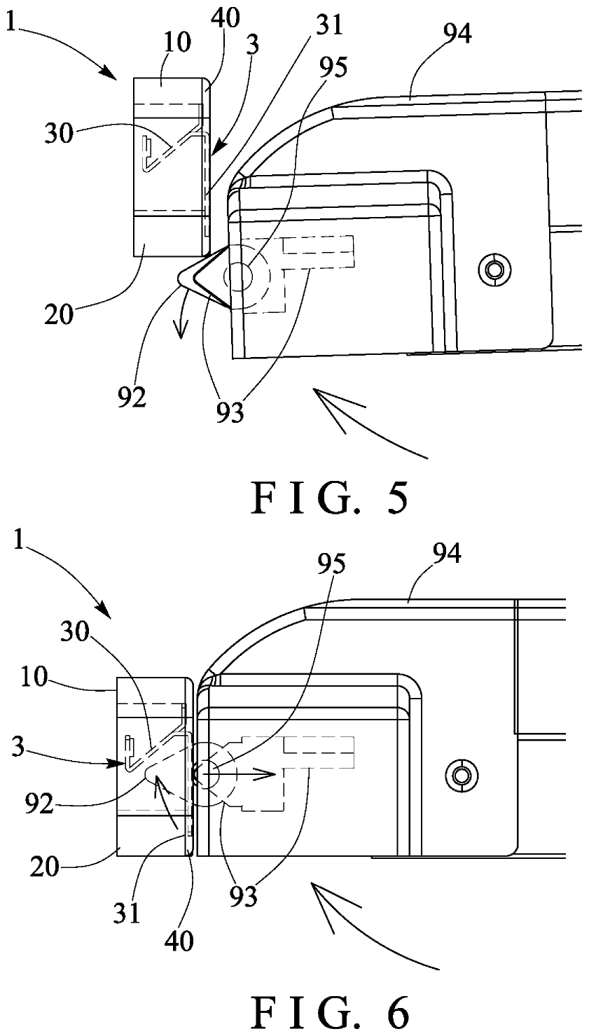

In operation, as shown in FIG. 5, when the press bar 94 that is attached to the door panel 90 is moved toward the housing 10 of the door lock device 1 that is attached to the door frame 91, the latch bolt 92 and the locking pin 93 will also be moved toward the housing 10, and the latch bolt 92 will be moved and forced to engage with the strike 20 and will be caused to be pivoted or rotated relative to the press bar 94 with or about a pivot axle 95 before the latch bolt 92 is engaged into the chamber 11 of the housing 10. At this moment, as shown in FIGS. 4 and 6, the locking pin 93 will be contacted or engage with one of the levers 31 and will be prevented from being engaged into the chamber 11 of the housing 10, and will be caused to be engaged with the latch bolt 92 for latching or locking the latch bolt 92 in place (FIG. 6).

It is to be noted that the provision and the extension of the levers 31, 32 from the board 30 may be provided for aligning with the locking pin 93 and for contacting or engaging with the locking pin 93 and for preventing the locking pin 93 from engaging into the chamber 11 of the housing 10 (FIGS. 4, 6). Accordingly, when the housing 10 of the door lock device 1 is attached to the door frame 91 at the wrong place or position other than or different from the selected or predetermined or required position or location, the provision of the levers 31, 32 of the board 30 may be selectively attached or mounted or secured to the housing 10 for selectively contacting or engaging with the locking pin 93 and for preventing the locking pin 93 from engaging into the chamber 11 of the housing 10, without adjusting the attaching location or position of the door lock device 1 to the door frame 91.

Accordingly, the door lock device in accordance with the present invention includes an improved and simplified structure or mechanism for allowing the door lock device to be suitably and easily and quickly and readily attached or mounted or secured to the door frame or door member without adjusting the attaching location or position of the door lock device to the door frame or door member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door lock device attached to a door member for working in cooperate with a latch bolt which is attached to a door element, said door element including a press bar engaged with a locking pin and the latch bolt, said door lock device comprising:
a housing attached to said door member, said housing including a chamber formed in said housing; and
a block device including a board engaged into said chamber of said housing and secured to said housing, and said board including a lever extended from said board for aligning with said locking pin and for selectively engaging with said locking pin and for preventing said locking pin from engaging into said chamber of said housing.

2. The door lock device as claimed in claim 1, wherein said housing includes a first side wall and a rear plate for forming said chamber of said housing, and said housing includes a second side wall having an opening communicating with said chamber of said housing for allowing said latch bolt to be engaged into said chamber of said housing.

3. The door lock device as claimed in claim 2, wherein said lever of said board is engaged in said opening of said second side wall of said housing.

4. The door lock device as claimed in claim 1, wherein said housing includes a cover secured to said housing, and said cover includes a space communicating with said chamber of said housing for allowing said latch bolt to be engaged into said chamber of said housing.

5. The door lock device as claimed in claim 4, wherein said cover includes an entrance formed in a front wall and communicating with said space of said cover for allowing said latch bolt to be engaged into said space of said cover and said chamber of said housing.

6. The door lock device as claimed in claim 4, wherein said lever of said board is engaged in said space of said cover.

7. The door lock device as claimed in claim 1, wherein said housing includes a notch formed in a front portion of said housing and communicating with said chamber of said housing, and a strike engaged in said notch of said housing for engaging with said latch bolt and for guiding said latch bolt into said chamber of said housing.
